(19) United States
(12) Patent Application Publication
(10) Pub. No.: US 2009/0140686 A1
(43) Pub. Date: Jun. 4, 2009

(54) METHOD FOR CONTROLLING AN ELECTRIC MOTOR, CONTROL UNIT AND ELECTRIC MOTOR

(75) Inventors: Willem Potze, Eindhoven (NL); Petrus Carolus Maria Frissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,306

(22) PCT Filed: Nov. 15, 2005
(86) PCT No.: PCT/IB2005/053766

§ 371 Date: May 15, 2007

(30) Foreign Application Priority Data
Nov. 19, 2004 (EP) 04105941.1

(51) Int. Cl. H02K 41/03

(52) U.S. Cl. 318/635

(57) ABSTRACT

For ensuring high-precision control of a planar motor (1) comprising a magnet (2) and j coils (3), j=1 . . . N, wherein currents T7 can flow through the coils (3) such that a force and a moment are generated that interact with the magnet (2), it has been proposed to determine force and moment needed to change the relative position of magnet (2) and coils from a present position to a desired position, and then to determine the currents T7 necessary for generating this force and moment in the computing means (43) of the control unit (4) of the electric motor (1). The coil currents are then regulated accordingly with regulating means (44). The relative position of magnet (2) and coils (3) is measured with measuring means (5) and fed into the first input means (41) of the control unit (4).

The invention relates to a method for controlling an electric motor, particularly a planar motor, wherein a magnet is positioned with respect to j coils, j=1 . . . N, wherein currents Iⱼ can flow through the coils such that a force and a moment are generated that interact with the magnet, a control unit for controlling an electric motor and an electric motor.

Electric motors are used in a variety of electrical equipment, especially equipment for high precision positioning. One field of application is for example the positioning of wafers during photolithography and other semiconductor processing with the help of linear or planar electric motors.

US 2003/0085676 A1 describes a system and method for independently controlling planar motors to move and position in six degrees of freedom. The electric planar motor comprises a moving magnet array and a coil array. The current supplied to the coils of the coils array interacts with the magnetic field of the magnets of the magnet array to generate forces between the magnet and coil arrays. The generated forces provide motion of the magnet array relative to the coil array in a first, second and third directions generally orthogonal to each other, as well as rotation about the first, second and third directions.

The method according to US 2003/0085676 A1 comprises the steps of determining the currents to be applied to the coils to generate forces between the magnet array and the coil array in a first, second, and third directions; determining the resultant torque about the first, second and third directions between the magnet array and the coil array generated by the forces generated by the determined currents; determining current adjustments to compensate for or cancel out the resultant torque; and applying a sum of the determined currents and determined current adjustments to the coils to interact with the magnetic fields of the magnetic array.

It is desirable to provide the possibility to control an electric motor, wherein a magnet is positioned with respect to one or more coils, wherein currents Ij, j=1 . . . N can flow through the coils such that a force and a moment are generated that interact with the magnet with high precision with respect to positioning and path to follow.

In a first aspect of the present invention, a method for controlling an electric motor, particularly a planar motor, wherein a magnet is positioned with respect to j coils, j=1 . . . N, wherein currents Iⱼ can flow through the coils such that a force and a moment are generated that interact with the magnet, with the steps of determining the present relative position of magnet and coils; determining the force \vec{F}^{prescr} and moment \vec{M}^{prescr} needed to change the relative position of magnet and coils from the present position to a desired position; determining the necessary currents Iⱼ^{nec} for generating the force \vec{F}^{prescr} and moment \vec{M}^{prescr}, wherein a further constraint concerning the system magnet-coils is taken into account for determining the currents Iⱼ^{nec}; and applying the determined currents Iⱼ^{nec} to the j coils.

The fact of considering from the beginning both force and moment necessary for a desired relative movement between magnet and coils allows for a very accurate control of the movement. By also taking into account a further constraint concerning the system magnet-coils, the system as a whole is optimized, and it provides the possibility of determining unique currents, thus enhancing the accuracy of the control.

The method according to the invention is especially advantageous, if the number N of current Ij is larger than the number of degrees of freedom of the electric motor, leading to unique currents Iⱼ^{nec}. The number of degrees of freedom is equivalent to the number of independent variables of \vec{F}^{prescr} and \vec{M}^{prescr}.

In preferred embodiments, the further constraint taken into account is the minimization of total power dissipation of the electric motor, leading to an electric motor optimized with respect to efficiency, or the constraint of having a prescribed distribution of force and moment in space, which can lead to a minimal deformation of the magnet plate during motion.

In most preferred embodiments of the present invention, the method of Lagrange is utilized for determining the unique currents Iⱼ^{nec}. A functional depending of currents Iⱼ and Lagrange multipliers λᵢ and taking into account the force and moment needed for changing the relative position between magnet and coils form the present position to a desired position as well as the chosen constraint is minimized, giving the currents Iⱼ^{nec}.

Advantageously, the force and moment needed for changing the relative position between magnet and coils from the present position to a desired position are not individually determined after every new position through computing, but a set of different forces \vec{F}^{prescr} and moments \vec{M}^{prescr}, each needed to change the relative position of magnet and coils from a present position to a desired position is computed beforehand and provided as database. This reduces the required computing resources and increases the reaction time during the control.

In a further aspect of the present invention, a control unit for controlling an electric motor, particularly a planar motor, wherein a magnet is positioned with respect to j coils, j=1 . . . N, wherein currents Iⱼ can flow through the coils such that a force and a moment are generated that interact with the magnet, is provided with first input means to receive information on the present relative position of magnet and coils; second input means to receive information on force \vec{F}^{prescr} and moment \vec{M}^{prescr} needed to change the relative position of magnet and coils from the present position to a desired position; computing means for computing the necessary currents Iⱼ^{nec} for generating the force \vec{F}^{prescr} and moment \vec{M}^{prescr}, wherein a further constraint the system magnet-coils is taken into account for defining Iⱼ^{nec}; and regulating means for regulating the currents Iⱼ to apply the computed currents Iⱼ^{nec} to the j coils.

The second input means of the control unit may be arranged as storing means for storing a set of forces \vec{F}^{prescr} and moments \vec{M}^{prescr}, each needed to change the relative position of magnet and coils from a present position to a desired position, or may be arranged as computing means for computing the \vec{F}^{prescr} and moment \vec{M}^{prescr} needed to change the relative position of magnet and coils from the present position to a desired position.

In a last aspect of the invention, an electric motor is provided, comprising a magnet and j coils j=1 . . . N, wherein currents Iⱼ, can flow through the coils such that a force and a moment are generated that interact with the magnet, a control unit according to the invention.

In preferred embodiments, the motor is a planar motor, in most preferred embodiments a planar motor with six degrees of freedom.

It is possible to have the coils move with respect to the magnet or both the coils and the magnet moving. But it is preferred to have the magnet move with respect to the coils. This avoids hoses and cables impeding the free motion of the coils.

Advantageously, the motor has means for measuring the relative position of magnet and coils, thus improving the accuracy of control and positioning.

A detailed description of the invention is provided below. Said description is provided by way of a non-limiting example to be read with reference to the attached drawings in which:

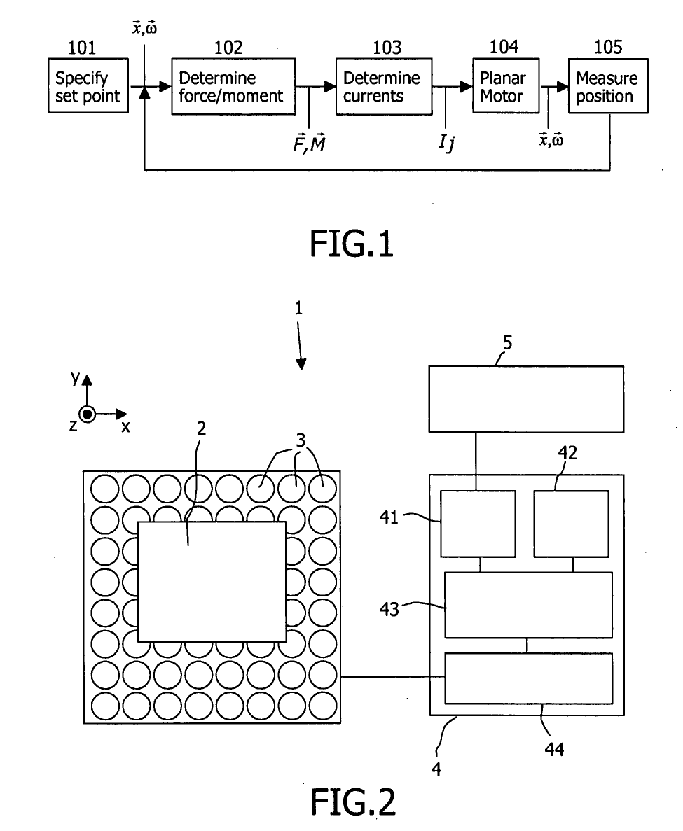

FIG. 1 is a block diagram illustrating an embodiment of the control method according to the invention; and

FIG. 2 is a block diagram illustrating an embodiment of the control unit and electric motor according to the invention.

FIG. 1 shows a block diagram illustrating an embodiment of the method according to the present invention as control loop the motor shown in FIG. 2. The magnet plate has to move along a prescribed path with a prescribed velocity. In order to realize this motion, a force and moment have to be exerted on the magnet plate. This force and moment are generated by the interaction of the magnetic field from the magnet plate and the currents flowing through the coils. These currents can be controlled, which means that the force and moment acting at the plate can be controlled.

In order to generate a required force and moment, the currents through the coils have to be prescribed. If a force and moment act at the plate, the plate will move and attains a new position. This position is measured with respect to position \vec{x} and orientation \vec{ω} of the magnet plate. The control loop takes care that the force and moment and therefore the currents are prescribed such that the plate follows the prescribed path with the prescribed velocity.

The starting point, i.e. the first relative position of magnet and coils, is given as set point in step 101. The magnet has to move along a path to a position \vec{x} and orientation \vec{ω} with a prescribed velocity. The necessary force and moment that have to act on the magnet are determined in step 102. It is possible to look the values up in a predetermined database as well as to punctually compute the values. In the next step 103, the necessary currents Ij are determined with the constraints, that the determined force and moment have to be generated, and a further constraint, e.g. minimal power dissipation or a prescribed distribution of force and moment. Examples on how to determine the currents will be given below.

Once the currents have been determined, they are applied to the one or more coils, thus moving the magnet with respect to the coils to position \vec{x} and orientation \vec{ω} with the prescribed velocity (step 104). Then the present relative position and orientation are measured (step 105) and taken as starting point for a new loop.

In FIG. 2, the corresponding electric motor 1 is shown. It has a magnet 2 positioned over an array of coils 3. Magnet 2 and coils 3 are arranged in the x-y-plane, with the z-direction pointing from the coils 3 to the magnet 2. As can be seen, only thirty coils are at least partly covered by the magnet 2. To simplify the control of the electric motor, especially the determination of the necessary currents, it is possible to have currents flow only through the coils 3 at least partly covered by the magnet 2 and to take only these coils into account, when determining force, momentum and currents. Then a path has to be divided into sub-paths, each sub-path having a defined set of coils 3 at least partly covered by the magnet 2. It will be further noticed, that the magnet 2 has not to be a single magnet, but can also be an array of magnets. This only makes the prescribed force and moment more complex.

The electric motor 1 is controlled by control unit 4. Through a first input means 41, the computing means 43 gets information on present relative position of magnet 2 and coils 3. This information can be provided by a measuring means 5, e.g. based on optical measurements with lasers. This information can also stored as first set point, corresponding to the last present position. But accuracy is improved, if the present position is at least from time to time measured independently.

The information on the prescribed force and momentum is provided to the computing means 43 through the second input means 42. This can be, for example, a storage means, where a database containing a set of forces and moments needed for changing the relative position from a present position to a desired position. It can also be a further computing means for computing the actual force and moment, and then even be integrated into the computing means 43.

Having all the information needed, the computing means 43 can compute the necessary currents for generating the determined force and moment. Examples on how to do the computing will be given below. The regulating means 44 then regulates the coil currents such that the computed currents are applied, thus moving the magnet 2 with respect to the coils 3 to position \vec{x} and orientation \vec{ω} with the prescribed velocity.

Possible ways of determining currents Iⱼ^{nec} are explained in the following with respect to the example of a planar motor with a moving plate and a number of fixed coils and having six degrees of freedom.

Currents flow through the coils such that a force and moment are applied to the magnet. Each current Iⱼ causes a force \vec{F}ⱼ and moment \vec{M}ⱼ acting on the magnet. Hence, the total force \vec{F} and moment \vec{M} acting on the magnet are

$${F}^{} = {\sum }_{j = 1}^{N} {{F}^{}}_{j} , {M}^{} = {\sum }_{j = 1}^{N} {{M}^{}}_{j} , \qquad ( 1 )$$

where N is the number of currents contributing to the exerted load on the magnet. The problem is to determine the currents Iⱼ, (j=1, . . . N) such that a prescribed force \vec{F}^{presc} and moment \vec{M}^{presc} are applied to the magnet.

Consider a unit current Iⱼ=1. This unit current through the coil exerts a force \vec{F}ⱼ¹ and moment \vec{M}j¹ on the magnet. A current with value Iⱼ will exert a force \vec{F}ⱼ=\vec{F}j¹Iⱼ and moment \vec{M}ⱼ=\vec{M}ⱼ¹Iⱼ (no summation over j). Superposition of all current Iⱼ, (j=1, . . . N) yields that the currents have to satisfy

$$( \begin{matrix}{{F}^{}}^{presc} \\ {{M}^{}}^{presc}\end{matrix} ) = {\sum }_{j = 1}^{N} ( \begin{matrix}{{F}^{}}_{j}^{1} \\ {{M}^{}}_{j}^{1}\end{matrix} ) {I}_{j} = ( \begin{matrix}{{F}^{}}_{1}^{1} & … & {{F}^{}}_{N}^{1} \\ {{M}^{}}_{1}^{1} & … & {{M}^{}}_{N}^{1}\end{matrix} ) ( \begin{matrix}{I}_{1} \\ ⋮ \\ {I}_{N}\end{matrix} . ) \qquad ( 2 )$$

To simplify the notations we introduce the vector \vec{T}^{presc}=(\vec{F}^{presc},\vec{M}^{presc})^{T}, the influence matrix

$$F = ( \begin{matrix}{{F}^{}}_{1}^{1} & … & {{F}^{}}_{N}^{1} \\ {{M}^{}}_{1}^{1} & … & {{M}^{}}_{N}^{1}\end{matrix} )$$

and current vector \vec{I}=(I₁, . . . , I_{N})^{T}. Then the constraint (2) is rewritten as

$${{T}^{}}^{presc} = F {I}^{} or {T}_{i}^{presc} = {\sum }_{j = 1}^{N} {F}_{ij} {I}_{j} ( i = 1 … 6 ) \qquad ( 3 )$$

If N=6 and the matrix of influence factors is not singular, the currents follow from (2) and are

\vec{I}=F⁻¹\vec{T}^{presc}. (4)

If N<6 and the rank of the matrix of influence factors F equals N, only unique currents Iⱼ (j=1 . . . N) exist, if the prescribed force and moment (\vec{F}^{presc},\vec{M}^{presc})^{T} are in the space spanned by (\vec{F}ⱼ¹,\vec{M}ⱼ¹)^{T} (j=1 . . . N). These currents are determined by the least squares solution of (3)

\vec{I}=(F^{T}F)⁻F^{T}\vec{T}^{presc}. (5)

If the prescribed force and moment are not in the space spanned by (\vec{F}ⱼ¹,\vec{M}ⱼ¹)^{T} (j=1 . . . N) no combination of currents exist that can generate the prescribed force and moment.

If N<6, the rank of the matrix of influence factors is smaller than N and if (\vec{F}^{presc},\vec{M}^{presc})^{T} is in the space spanned by (\vec{F}ⱼ¹,\vec{M}ⱼ¹)^{T} (j=1 . . . N), the currents Iⱼ (j=1 . . . N) to generate the prescribed force \vec{F}^{presc} and moment \vec{M}^{presc} are not unique. In this case and in the case that N>6 additional demands have to be imposed on the currents to obtain unique values Iⱼ to generate the prescribed force and moment.

Generally speaking, the required force and moment represent 6 constraints concordant with the six degrees of freedom of the motor. In general, the number N of coils that influence the force and moment acting at the plate is greater than 6. A typical number for the number of currents is between 20 and 30, e.g. 27. Then the problem is how to prescribe the currents in order that a required force and moment on the plate are generated. Hence, N>6 variables have to be determined, such that 6 constraints are satisfied.

The currents are the solution of an optimization/minimization problem with the constraint that the required force \vec{F}^{required} and moment \vec{M}^{required} are generated. Hence, if one uses the method of Lagrange, the currents are the variables at which the functional

$$J ( {I}_{1} , … , {I}_{N} , {λ}_{1} , … , {λ}_{6} ) = G ( {I}_{1} , … , {I}_{N} ) - {\sum }_{i = 1}^{6} {λ}_{i} ( {T}_{i}^{required} - {T}_{i} ( {I}_{1} , … , {I}_{N} ) ) \qquad ( 6 )$$

has its minimum. The index i in the expression for J indicates components of the vectors \vec{T}

$$( {T}^{} = ( \begin{matrix}{F}^{} \\ {M}^{}\end{matrix} ) )$$

and \vec{λ}, λ_{1, . . . , 6} being Lagrange multipliers. The function \vec{T}(I₁, . . . , I_{N}) defines the relation between the currents I₁, . . . , I_{N} and the generated force \vec{P} and moment \vec{M}. In this case the force and moment are linear dependent on the currents, hence \vec{T}=A(\vec{x},\vec{ω})\vec{I}, where the tensor A(\vec{x},\vec{ω}) depends on the position \vec{x} and the orientation \vec{ω} of the magnet plate with respect to the fixed coils. The function G(I₁, . . . , I_{N}) defines the function to be minimized, with the constraint that the required force and moment

$$( {{T}^{}}^{required} = ( \begin{matrix}{{F}^{}}^{required} \\ {{M}^{}}^{required}\end{matrix} ) )$$

are generated, and is equivalent to the further constraint to be taken into account for determining Iⱼ^{necc}. This function G(I₁, . . . , I_{N}) has to be chosen. Then, the condition that the function J has to be minimal generates sufficient extra conditions to determine uniquely the currents I₁, . . . , I_{N} (and it determines uniquely the extra introduced so called Lagrange multipliers λ₁, . . . , λ₆). Hence, unique currents I₁, . . . , I_{N} are determined that minimize some function G(I₁, . . . , I_{N}) with the constraint that the required force \vec{F}^{required} and moment \vec{M}^{required} are generated.

1. Minimal Power Dissipation

The function G(I₁, . . . , I_{N}) to be optimized has to be chosen. A suitable choice is the total power dissipation in the coils, hence

$$G ( {I}_{1} , … , {I}_{N} ) = {\sum }_{i = 1}^{N} {R}_{i} {I}_{i}^{2} \qquad ( 7 )$$

where the Rᵢ are the resistances of the coils and the power dissipation caused by a current Iⱼ is Pⱼ=RⱼIⱼ² (no summation). If N>6 an additional demand on the currents Iⱼ can be that the total power dissipation of the currents is minimal.

Next, the currents through the coils are determined by minimizing the total power dissipation with the constraint (3), hence the currents are determined by minimizing the functional

$$J ( {I}_{1} , … , {I}_{N} ) = {\sum }_{j = 1}^{N} {R}_{j} {I}_{j}^{2} - {\sum }_{i = 1}^{6} {λ}_{i} ( {T}_{i} - {\sum }_{j = 1}^{N} {F}_{ij} {I}_{j} ) , \qquad ( 8 )$$

where λᵢ are Lagrange multipliers.

This functional has a minimum if

$$\begin{matrix}\frac{\partial J}{\partial {I}_{k}} = 2 {R}_{k} {I}_{k} + {\sum }_{i = 1}^{6} {λ}_{i} {F}_{ik} = 0 ( k = 1 … N ) \\ and & ( 9 ) \\ {T}_{i}^{presc} = {\sum }_{j = 1}^{N} {F}_{ij} {I}_{j} ( i = 1 … 6 ) . & ( 3 )\end{matrix}$$

To simplify the solution of the equations (3) and (9), the currents are written as

$${I}_{k} = {\sum }_{i = 1}^{6} {λ}_{i} {I}_{ki} ( k = 1 … N ) or {I}^{} = I {λ}^{} . \qquad ( 10 )$$

Substitution of (10) in (9) yields

$$\begin{matrix}\frac{\partial J}{\partial {I}_{k}} = 2 {R}_{k} {\sum }_{i = 1}^{6} {I}_{ki} {λ}_{i} + {\sum }_{i = 1}^{6} {λ}_{i} {F}_{ik} \\ = {\sum }_{i = 1}^{6} ( 2 {R}_{k} {I}_{ki} + {F}_{ik} ) {λ}_{i} \\ = 0 ( k = 1 … N )\end{matrix} \qquad ( 11 )$$

Hence solving (11) yields

$${I}_{ik} = - \frac{{F}_{ik}}{2 {R}_{k}} ( i = 1 … 6 ) ( k = 1 … N ) \qquad ( 12 )$$

The Lagrange multipliers λᵢ follow from the constraint (3). Substitution of (10) and (12) in (3) yields

$$\begin{matrix}\begin{matrix}{T}_{i}^{presc} = {\sum }_{j = 1}^{N} {F}_{ij} {I}_{j} \\ = {\sum }_{j = 1}^{N} {F}_{ij} {I}_{j} \\ = {\sum }_{j = 1}^{N} {F}_{ij} {\sum }_{k = 1}^{6} {λ}_{k} {I}_{jk} \\ = {\sum }_{k = 1}^{6} {λ}_{k} {\sum }_{j = 1}^{N} {F}_{ij} {I}_{jk} \\ = {\sum }_{k = 1}^{6} {λ}_{k} {\sum }_{j = 1}^{N} \frac{- {F}_{ij} {F}_{kj}}{2 {R}_{j}}\end{matrix} & ( 13 ) \\ or \\ {T}_{i}^{presc} = {\sum }_{k = 1}^{6} {A}_{ik} {λ}_{k} , ( i = 1 … 6 ) with {A}_{ik} = {\sum }_{j = 1}^{N} \frac{- {F}_{ij} {F}_{kj}}{2 {R}_{j}} \\ or \\ {{T}^{}}^{presc} = A {λ}^{} . & \end{matrix}$$

Hence the Lagrange multipliers have to be solved from (13) and are given by

\vec{λ}=A⁻¹\vec{T}^{presc}. (14)

To obtain the currents Iⱼ, (12) and (14) are substituted in (10), then

$${I}_{k} = {\sum }_{i = 1}^{6} {λ}_{i} {I}_{ki} = {\sum }_{i = 1}^{6} {λ}_{i} \frac{- {F}_{ik}}{2 {R}_{k}} ( k = 1 … N ) . \qquad ( 15 )$$

Hence, the currents given by (15) are the currents that deliver the prescribed force \vec{F}^{presc} and moment \vec{M}^{presc} with minimal power dissipation.

As example, consider the case that all resistances of the coils are equal, hence Rⱼ=R (j=1 . . . N). Then the matrices A (13) and I (12) are

$$A = \frac{- 1}{2 R} {FF}^{T} , I = \frac{- 1}{2 R} {F}^{T} \qquad ( E .1 )$$

and the currents are given by

$$\begin{matrix}{I}^{} = I {A}^{- 1} {{T}^{}}^{presc} \\ = \frac{- 1}{2 R} {{F}^{T} ( \frac{- 1}{2 R} {FF}^{T} )}^{- 1} {{T}^{}}^{presc} \\ = {{F}^{T} ( {FF}^{T} )}^{- 1} {{T}^{}}^{presc} .\end{matrix} \qquad ( E .2 )$$

Hence, as expected the currents are independent of the resistance of the coils.

2. Prescribed Force and Moment Distribution

Another requirement can be a desired force and moment per unit area distribution over the plate, hence a desired distribution \vec{T}_{dis}^{desired}(\vec{x}). Then the function G(I₁, . . . I_{N}) becomes

$$G ( {I}_{1} , … , {I}_{N} ) = \int {\int }_{D} ( {{T}^{}}_{dis}^{desired} ( {x}^{} ) - {{T}^{}}_{dis} ( {x}^{} ) ) \cdot ( {{T}^{}}_{dis}^{desired} ( {x}^{} ) - {{T}^{}}_{dis} ( {x}^{} ) ) d a , \qquad ( 16 )$$

where the integration has to be carried out over the area D of the plate and \vec{T}_{dis}(\vec{x}) represents the generated force and moment per unit area of the plate at a location \vec{x} of the plate. For practical reasons in general a numerical method (e.g. discretization) is used to calculate the surface integral. The area D of the plate can be divided into M sub-areas Dₖ, then the integral over D can be approximated by

$$G ( {I}_{1} , … , {I}_{N} ) \approx {\sum }_{k = 1}^{M} ( {\vec{T}}_{dis , k}^{desired} - {\vec{T}}_{dis , k} ) \cdot ( {\vec{T}}_{dis , k}^{desired} - {\vec{T}}_{dis , k} ) \qquad ( 17 )$$

where \vec{T}_{dis,k}^{desired} represents the desired force and moment acting at the part Dₖ of the total area D of the magnet plate and \vec{T}_{dis,k}=A^{k}\vec{I} represents the force and moment acting at Dₖ due to the currents through the coils. The total force and moment are given by

$${\vec{T}}^{total} = {\sum }_{k = 1}^{M} {\vec{T}}_{dis , k} = {\sum }_{k = 1}^{M} {A}^{k} \vec{I} = A \vec{I} . \qquad ( 18 )$$

This total force and moment have to be equal to the required force and moment \vec{T}^{required} acting at the magnet plate. Hence, the functional to be optimized becomes

$$J ( \begin{matrix}{I}_{1} , … , {I}_{N} , \\ {λ}_{1} , … , {λ}_{6}\end{matrix} ) = {\sum }_{k = 1}^{M} \{ \begin{matrix}( {\vec{T}}_{dos , k}^{desired} - {A}^{k} I ) \cdot \\ ( {\vec{T}}_{dis , k}^{desired} - {A}^{k} I )\end{matrix} \} - \vec{λ} \cdot ( {\vec{T}}^{required} - AI ) \qquad ( 19 )$$

More in detail, one has to divide the magnet plate into a number of area elements. These area elements are not necessarily equal. Consider a unit current Iⱼ=1. This unit current through the coil exerts a force \vec{A}ⱼ^{k} and moment \vec{B}ⱼ^{k} on area element k, if this area element is considered to be decoupled from all other area elements. A current with value Iⱼ will exert a force \vec{K}ⱼ^{k}=\vec{A}ⱼ^{k}Iⱼ and moment \vec{L}ⱼ^{k}=\vec{B}ⱼ^{k}Iⱼ (no summation over j) on area element k. Superposition of all current Iⱼ, (j=1 . . . N) yields the following force \vec{F}^{k} and moment \vec{M}^{k} on area element k

\vec{F}^{k}=A^{k}\vec{I},\vec{M}^{k}=B^{k}\vec{I},k=1, . . . , M, (20)

where M is the number of area elements. The total force and moment acting at the magnet plate follows from the coupling of all area elements, hence the total force \vec{F}^{tot} and total moment \vec{M}^{tot} are

$$\begin{matrix}{\vec{F}}^{tot} = {\sum }_{k = 1}^{M} {\vec{F}}^{k} \\ = {\sum }_{k = 1}^{M} {A}^{k} \vec{I} {\vec{M}}^{tot} \\ = {\sum }_{k = 1}^{M} ( {\vec{M}}^{k} + {\vec{x}}^{k} \times {\vec{F}}^{k} ) \\ = {\sum }_{k = 1}^{M} ( {B}^{k} \vec{I} + {\vec{x}}^{k} \times {A}^{k} \vec{I} )\end{matrix} \qquad ( 21 )$$

where \vec{x}^{k} is the vector from the point at which the total force and moment act to the location on the area element at which the force \vec{F}^{k} and moment \vec{M}^{k} act.

The distribution of force and moment over the magnet plate can be prescribed. If the magnet plate is discretized in area elements, this means that the distribution of force \vec{F}^{k} and moment \vec{M}^{k} acting on the area elements can be prescribed. Then the problem is to determine the currents trough the coils which deliver (approximately) these force and moment distributions. However, the currents through the coils have to generate a prescribed total force and total moment acting on the magnet plate. Hence, the following optimization problem has to be solved.

Determine the currents \vec{I} such that the prescribed distribution of forces \vec{F}^{k} and moments \vec{M}^{k} are satisfied in a least squares sense, with the constraint that the required total force \vec{F}^{tot} and moment \vec{M}^{tot} are generated. Hence the currents follow from minimizing the functional

$$J ( \vec{I} , \vec{λ} , \vec{μ} ) = {\sum }_{k = 1}^{M} \{ \begin{matrix}( {\vec{F}}^{k} - {A}^{k} \vec{I} ) \cdot ( {\vec{F}}^{k} - {A}^{k} \vec{I} ) + \\ ( {\vec{M}}^{k} - {B}^{k} \vec{I} ) \cdot ( {\vec{M}}^{k} - {B}^{k} \vec{I} )\end{matrix} \} - \vec{λ} \cdot ( {\vec{F}}^{tot} - {\sum }_{k = 1}^{M} {A}^{k} \vec{I} ) - \vec{μ} \cdot ( {\vec{M}}^{tot} - {\sum }_{k = 1}^{M} ( {B}^{k} \vec{I} + {\vec{x}}^{k} \times {A}^{k} {I}^{=} ) ) , \qquad ( 22 )$$

where \vec{λ} and \vec{μ} are Lagrange multipliers.

In order to determine the conditions for which the functional (22) has a minimum, we write it as a function of the components of the vectors \vec{I}, \vec{λ} and \vec{μ}, hence

$$J ( {I}_{i} , {λ}_{j} , {μ}_{k} ) = {\sum }_{m = 1}^{M} \{ \begin{matrix}( {\vec{F}}_{n}^{m} - {A}_{np}^{m} {I}_{p} ) \cdot ( {\vec{F}}_{n}^{m} - {A}_{np}^{m} {I}_{p} ) + \\ ( {M}_{n}^{m} - {B}_{np}^{m} {I}_{p} ) \cdot ( {M}_{n}^{m} - {B}_{np}^{m} {I}_{p} )\end{matrix} \} - {λ}_{r} \cdot ( {\vec{F}}_{r}^{tot} - {\sum }_{m = 1}^{M} {A}_{rp}^{m} {I}_{p} ) - {μ}_{s} \cdot ( {M}_{s}^{tot} - {\sum }_{m = 1}^{M} ( {B}_{sp}^{m} {I}_{p} + {ɛ}_{sqt} {x}_{q}^{m} {A}_{tp}^{m} {I}_{p} ) ) \qquad ( 23 )$$

where

ε_{sqt}=1, if sqt is 123, 312, 231,

ε_{sqt}=−1, if sqt is 132, 321, 213,

ε_{sqt}=0, otherwise.

Note, that in the expression of the function (23), the Einstein summation convention is used for the indices n, p, q, r, s and t (i.e. summation over these indices if they appear twice in a term). Differentiation with respect to Iᵢ, λⱼ and μₖ and setting the result to zero, yields

$$\begin{matrix}0 = \frac{\partial J}{\partial {I}_{i}} = {\sum }_{m = 1}^{M} \{ \begin{matrix}- 2 ( {\vec{F}}_{n}^{m} - {A}_{np}^{m} {I}_{p} ) {A}_{ni}^{m} - \\ 2 ( {M}_{n}^{m} - {B}_{np}^{m} {I}_{p} ) {B}_{ni}^{m}\end{matrix} \} - {λ}_{r} {\sum }_{m = 1}^{M} {A}_{ri}^{m} - {μ}_{s} {\sum }_{m = 1}^{M} ( {B}_{si}^{m} + {ɛ}_{sqt} {x}_{q}^{m} {A}_{ti}^{m} ) & ( 24 ) \\ 0 = \frac{\partial J}{\partial {I}_{i}} = - 2 {\sum }_{m = 1}^{M} ( {A}_{ni}^{m} {\vec{F}}_{n}^{m} + {B}_{ni}^{m} {M}_{n}^{m} ) + 2 {\sum }_{m = 1}^{M} ( {A}_{ni}^{m} {A}_{np}^{m} + {B}_{ni}^{m} {B}_{np}^{m} ) {I}_{p} + {\sum }_{m = 1}^{M} {A}_{ri}^{m} {λ}_{r} + {\sum }_{m = 1}^{M} ( {B}_{si}^{m} + {ɛ}_{sqt} {x}_{q}^{m} {A}_{ti}^{m} ) {μ}_{s} , & ( 25 ) \\ 0 = \frac{\partial J}{\partial {λ}_{j}} = - ( {F}_{j}^{tot} - {\sum }_{m = 1}^{M} {A}_{jp}^{m} {I}_{p} ) , & ( 26 ) \\ 0 = \frac{\partial J}{\partial {μ}_{k}} = - ( {M}_{k}^{tot} - {\sum }_{m = 1}^{M} ( {B}_{kp}^{m} {I}_{p} + {ɛ}_{kqt} {x}_{q}^{m} {A}_{tp}^{m} {I}_{p} ) ) . & ( 27 )\end{matrix}$$

The functional (22) has a minimum, if (25), (26) and (27) are fulfilled. In vector and matrix notation these expressions become

$$\begin{matrix}\vec{0} = - 2 {\sum }_{k = 1}^{M} \{ {( {A}^{k} )}^{T} {\vec{F}}^{k} + {( {B}^{k} )}^{T} {\vec{M}}^{k} \} + 2 {\sum }_{k = 1}^{M} \{ {( {A}^{k} )}^{T} {A}^{k} + {( {B}^{k} )}^{T} {B}^{k} \} \vec{I} + {\sum }_{k = 1}^{M} {( {A}^{k} )}^{T} \cdot \vec{λ} + {\sum }_{k = 1}^{M} \{ {( {B}^{k} )}^{T} + {( {D}^{k} )}^{T} \} \cdot \vec{μ} , & ( 28 ) \\ \vec{0} = - {\vec{F}}^{tot} + {\sum }_{k = 1}^{M} {A}^{k} \vec{I} , & ( 29 ) \\ \vec{0} = - {\vec{M}}^{tot} + {\sum }_{k = 1}^{M} \{ {B}^{k} + {D}^{k} \} \vec{I} , & ( 30 )\end{matrix}$$

where the components of matrix D^{k} are Dᵢⱼ^{k}=ε_{ipq}xₚ^{k}A_{qj}^{k}, with

ε_{ipq}=1, if ipq is 123, 312, 231,

ε_{ipq}=−1, if ipq is 132, 321, 213, (31)

ε_{ipq}=0 otherwise.

Next the following definitions are introduced

$$A = {\sum }_{k = 1}^{M} {A}^{k} , \\ B = {\sum }_{k = 1}^{M} {B}^{k} , \\ C = 2 {\sum }_{k = 1}^{M} \{ {( {A}^{k} )}^{T} {A}^{k} + {( {B}^{k} )}^{T} {B}^{k} \} , \\ D = {\sum }_{k = 1}^{M} {D}^{k} , \\ \vec{E} = 2 {\sum }_{k = 1}^{M} \{ {( {A}^{k} )}^{T} {\vec{F}}^{k} + {( {B}^{k} )}^{T} {\vec{M}}^{k} \}$$

Then the conditions (28)-(30) for a minimum of the functional (22) become

C\vec{I}=\vec{E}−A^{T}\vec{λ}−(B+D)^{T}\vec{μ} (32)

\vec{F}^{tot}=A\vec{I} (33)

\vec{M}^{tot}=(B+D)\vec{I} (34)

From (32) it follows that

\vec{I}=C⁻¹\vec{E}−C⁻¹A^{T}\vec{λ}−C⁻¹(B+D)^{T}\vec{μ} (35)

that can be rewritten as

$$\vec{I} = {C}^{- 1} \vec{E} - {{C}^{- 1} ( \begin{matrix}A \\ B + D\end{matrix} )}^{T} ( \begin{matrix}\vec{λ} \\ \vec{μ}\end{matrix} ) . \qquad ( 36 )$$

Substitution of (35) in (33) and (34) yields, respectively,

\vec{F}^{tot}=AC⁻¹\vec{E}−AC⁻¹A^{T}\vec{λ}−AC⁻¹(B+D)^{T}\vec{μ}, (37)

\vec{M}^{tot}=(B+D)C⁻¹\vec{E}−(B+D)C⁻¹A^{T}\vec{λ}−(B+D)C⁻¹(B+D)^{T}\vec{λ}. (38)

Combining (37) and (38) gives the following set of linear equations for the Lagrange multipliers \vec{λ} and \vec{μ}

$$( \begin{matrix}A {C}^{- 1} {A}^{T} & A {{C}^{- 1} ( B + D )}^{T} \\ ( B + D ) {C}^{- 1} {A}^{T} & ( B + D ) {{C}^{- 1} ( B + D )}^{T}\end{matrix} ) ( \begin{matrix}\vec{λ} \\ \vec{μ}\end{matrix} ) = ( \begin{matrix}A \\ B + D\end{matrix} ) {C}^{- 1} \vec{E} - ( \begin{matrix}{\vec{F}}^{tot} \\ {\vec{M}}^{tot}\end{matrix} ) \qquad ( 39 )$$

Hence the solution for \vec{λ} and \vec{μ} is

$$( \begin{matrix}\vec{λ} \\ \vec{μ}\end{matrix} ) = {( \begin{matrix}A {C}^{- 1} {A}^{T} & A {{C}^{- 1} ( B + D )}^{T} \\ ( B + D ) {C}^{- 1} {A}^{T} & ( B + D ) {{C}^{- 1} ( B + D )}^{T}\end{matrix} )}^{- 1} \{ ( \begin{matrix}A \\ B + D\end{matrix} ) {C}^{- 1} {E}^{} - ( \begin{matrix}{\vec{F}}^{tot} \\ {\vec{M}}^{tot}\end{matrix} ) \} \qquad ( 40 )$$

Substitution of (40) into equation (36) gives the closed expression for the currents, directly as a function of prescribed force and moment.

The prescribed force distribution and moment distribution can be, for example, uniform. In the case that the total force and moment are prescribed with the condition of a uniform force and moment distribution on the area elements and with the condition that the area elements are equal in size, the force \vec{F}^{k} and moment \vec{M}^{k} acting at a surface element k are

$${\vec{F}}^{k} = \frac{1}{M} {\vec{F}}^{tot} , {\vec{M}}^{k} = \frac{1}{M} ( {\vec{M}}^{tot} - {\sum }_{i = 1}^{M} {\vec{x}}^{i} \times {\vec{F}}^{i} ) . \qquad ( E .3 )$$

In the case that the area elements are not equal and have size O^{k}, with

$$O = {\sum }_{k = 1}^{M} {O}^{k}$$

the total area of the magnet plate, the forces \vec{F}^{k} and moments \vec{M}^{k} belonging to a uniform distribution are

$${\vec{F}}^{k} = \frac{{O}^{k}}{O} {\vec{F}}^{tot} , {\vec{M}}^{k} = \frac{{O}^{k}}{O} ( {\vec{M}}^{tot} - {\sum }_{i = 1}^{M} {\vec{x}}^{i} \times {\vec{F}}^{i} ) . \qquad ( E .4 )$$

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 electric motor
2 magnet
3 coil
4 control unit
5 measuring means
41 first input means
42 second input means
43 computing means
44 regulating means
101 step of specifying set point
102 step of determining force/moment
103 step of determining currents
104 step of moving magnet
105 step of measuring position

1. A method for controlling an electric motor, particularly a planar motor, wherein a magnet is positioned with respect to j coils, j=1 . . . N, wherein currents Iⱼ can flow through the coils such that a force and a moment are generated that interact with the magnet, with the steps of:
determining the present relative position of magnet and coils;
determining the force \vec{F}^{prescr} and moment \vec{M}^{prescr} needed to change the relative position of magnet and coils from the present position to a desired position;
determining the necessary currents Iⱼ^{necc} for generating the force \vec{F}^{prescr} and moment \vec{M}^{prescr}, wherein a further constraint concerning the system magnet-coil is taken into account for defining the currents Iⱼ^{nec};
applying the determined currents Iⱼ^{nec} to the j coils.

2. The method according to claim 1, wherein the number N of currents Iⱼ is larger than the number of degrees of freedom of the electric motor.

3. The method according to claim 1, wherein the further constraint is minimal power dissipation.

4. The method according to claim 1, wherein j>1 and the further constraint is a prescribed distribution of force and moment.

5. The method according to claim 1, wherein a Lagrange functional is minimized for determining the currents Iⱼ^{nec}.

6. The method according to claim 1, wherein a set of different forces \vec{F}^{prescr} and moments \vec{M}^{prescr}, each needed to change the relative position of magnet and coils from a present position to a desired position, is determined.

7. A control unit (4) for controlling an electric motor (1), particularly a planar motor, wherein a magnet (2) is positioned with respect to j coils (3), j=1 . . . N, wherein currents Iⱼ can flow through the coils (3) such that a force and a moment are generated that interact with the magnet (2), with
first input means (41) to receive information on the present relative position of magnet (2) and coils (3);
second input means (42) to receive information on force \vec{F}prescr and moment \vec{M}^{prescr} needed to change the relative position of magnet (2) and coils (3) from the present position to a desired position;
computing means (43) for computing the necessary currents Iⱼ^{nec} for generating the force \vec{F}^{prescr} and moment \vec{M}^{prescr}, wherein a further constraint concerning the system magnet-coil is taken into account for determining the currents Iⱼ^{nec};
regulating means (44) for regulating the currents Iⱼ to apply the computed currents Iⱼ^{nec} to the j coils (3).

8. The control unit according to claim 7 wherein the second input means (42) is arranged as storing means for storing a set of forces \vec{F}^{prescr} and moments \vec{M}^{prescr}, each needed to change the relative position of magnet (2) and coils (3) from a present position to a desired position.

9. The control unit according to claim 7, wherein the second input means (42) is arranged as computing means for computing the \vec{F}^{prescr} and moment \vec{M}^{prescr} needed to change the relative position of magnet (2) and coils (3) from the present position to a desired position.

10. An electric motor (1), comprising a magnet (2) and j coils (3), j=1 . . . N, wherein currents Iⱼ can flow through the coils (3) such that a force and a moment are generated that interact with the magnet (2), a control unit (4) according to claim 7.

11. The electric motor according to claim 10, wherein the motor (1) is a planar motor.

12. The electric motor according to claim 10, wherein the motor (1) is a planar motor with six degrees of freedom.

13. The electric motor according to claim 10, wherein the magnet (2) is movable with respect to the coils (3).

14. The electric motor according to claim 10, having means (5) for measuring the relative position of magnet (2) and coils (3).
